(19) United States
(12) Patent Application Publication
(10) Pub. No.: US 2025/0323409 A1
(43) Pub. Date: Oct. 16, 2025

(54) TRANSPARENT ANTENNA PHASE ARRAY

(71) Applicant: INDUSTRIAL TECHNOLOGY RESEARCH INSTITUTE, Hsinchu (TW)

(72) Inventors: Bing-Hsun LI, Hsinchu City (TW); Li-Yang TSAI, Luodong Township (TW); Kuang-Hui SHIH, Tainan City (TW); Yu-Ching LIN, Zhudong Township (TW)

(73) Assignee: INDUSTRIAL TECHNOLOGY RESEARCH INSTITUTE, Hsinchu (TW)

(21) Appl. No.: 18/921,432

(22) Filed: Oct. 21, 2024

Related U.S. Application Data
(60) Provisional application No. 63/633,878, filed on Apr. 15, 2024.

(30) Foreign Application Priority Data
Aug. 23, 2024 (TW) 113131831

(51) Int. Cl. H01Q 1/12; H01Q 1/48; H01Q 3/36

(52) U.S. Cl. CPC H01Q 1/1271; H01Q 1/48; H01Q 3/36

(57) ABSTRACT

A transparent antenna phase array is provided. A transparent antenna phase array includes a transparent dielectric layer and a plurality of antenna units. The transparent dielectric layer includes two transparent material layers. Each of the antenna units includes an antenna conductive layer, a feed-in transmission line conductive layer and a main ground opening conductive layer. The antenna conductive layer is disposed on one of the transparent material layers. The main ground opening conductive layer is disposed on one of the transparent material layers, and is located between the antenna conductive layer and the feed-in transmission line conductive layer. The antenna conductive layer, the feed-in transmission line conductive layer and the main ground opening conductive layer are mesh structures. The transparent material layers separate the antenna conductive layer and the main ground opening conductive layer, and separate the feed-in transmission line conductive layer and the main ground opening conductive layer.

This application claims the benefit of US Provisional application Ser. No. 63,633/878, filed Apr. 15, 2024 and Taiwan application Serial No. 113131831, filed Aug. 23, 2024, the disclosure of which is incorporated by reference herein in its entirety.

### TECHNICAL FIELD

The disclosure relates to a transparent antenna phase array.

### BACKGROUND

In the current communication system, most communication equipment needs to have the ability to communicate anytime and anywhere without geographical restrictions. However, when the transmission distance is long and the signal attenuation is serious, the antenna needs to provide ultra-high gain performance to deliver the signal.

In some communication applications, the antenna needs to have the ability to track movement. In addition, when electromagnetic waves pass through the air or ionosphere, the polarization direction of the electromagnetic waves may be changed, reducing the efficiency of antenna transmission. Therefore, how to enhance the gain, tracking and radiation capabilities of the launch system is the direction that the industry is striving to improve.

### SUMMARY

The disclosure is directed to a transparent antenna phase array.

According to one embodiment, a transparent antenna phase array is provided. The transparent antenna phase array includes a transparent dielectric layer and a plurality of antenna units. The transparent dielectric layer includes at least two transparent material layers. Each of the antenna units includes an antenna conductive layer, a feed-in transmission line conductive layer and a main ground opening conductive layer. The antenna conductive layer is disposed on one of the transparent material layers. The feed-in transmission line conductive layer is disposed on one of the transparent material layers. The main ground opening conductive layer is disposed on one of the transparent material layers, and disposed between the antenna conductive layer and the feed-in transmission line conductive layer. The antenna conductive layer, the feed-in transmission line conductive layer and the main ground opening conductive layer are mesh structures. The transparent material layers separate the antenna conductive layer and the main ground opening conductive layer, and separate the feed-in transmission line conductive layer and the main ground opening conductive layer.

According to another embodiment, a transparent antenna phase array is provided. The transparent antenna phase array includes a transparent dielectric layer, a plurality of antenna units and a first phase shift unit. The antenna units are disposed on the transparent dielectric layer. The antenna units are at least divided into a first group and a second group. Each of the antenna units is a mesh structure. Each of the antenna units of the first group has a first feed path extending in a first direction, and each of the antenna units of the second group has a second feed path extending in a second direction. The second direction is different from the first direction. The first phase shift unit is connected to the second feed path.

According to an alternative embodiment, a transparent antenna phase array is provided. The transparent antenna phase array includes a transparent dielectric layer, a plurality of antenna units, a plurality of beamforming circuits and at least one feeding integrated network. The antenna units are arrayed on the transparent dielectric layer. Each of the antenna units is a mesh structure. The beamforming circuits are disposed on the transparent dielectric layer. Each of the beamforming circuits is connected to some of the antenna units. The at least one feeding integrated network is connected to the beamforming circuits.

### BRIEF DESCRIPTION OF THE DRAWINGS

FIG. 1 illustrates a cross-sectional view of a transparent antenna phase array according to an embodiment of the present disclosure.

FIG. 2 shows a top view of a transparent antenna phase array according to an embodiment of the present disclosure.

FIG. 3 illustrates a top view of a transparent antenna phase array according to another embodiment of the present disclosure.

FIG. 4 illustrates a top view of a transparent antenna phase array according to another embodiment of the present disclosure.

FIG. 5 illustrates a top view of a transparent antenna phase array according to another embodiment of the present disclosure.

FIG. 6 illustrates a top view of a transparent antenna phase array according to another embodiment of the present disclosure.

FIG. 7 illustrates a schematic diagram of the antenna unit according to an embodiment of the present disclosure.

FIG. 8 illustrates a schematic diagram of a beamforming circuit according to an embodiment of the present disclosure.

FIG. 9 shows a top view of a transparent antenna phase array and a schematic diagram of the connection between the beamforming circuits and the feeding integrated network according to another embodiment of the present disclosure.

FIG. 10 shows a top view of a transparent antenna phase array and a schematic diagram of the connection between the beamforming circuits and the feeding integrated network according to another embodiment of the present disclosure.

FIG. 11 illustrates a top view of a transparent antenna phase array and a schematic diagram of the connection between the beamforming circuits and the feeding integrated networks according to another embodiment of the present disclosure.

FIG. 12 illustrates a top view of a transparent antenna phase array and a schematic diagram of the connection between the beamforming circuits and the feeding integrated networks according to another embodiment of the present disclosure.

FIG. 13A illustrates a top view of a transparent antenna phase array according to another embodiment of the present disclosure.

FIG. 13B illustrates a schematic diagram of the connection between the beamforming circuits and the feeding integrated networks of the transparent antenna phase array of the FIG. 13A.

FIG. 14 illustrates a schematic diagram of the connection between the beamforming circuit and the antenna unit according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

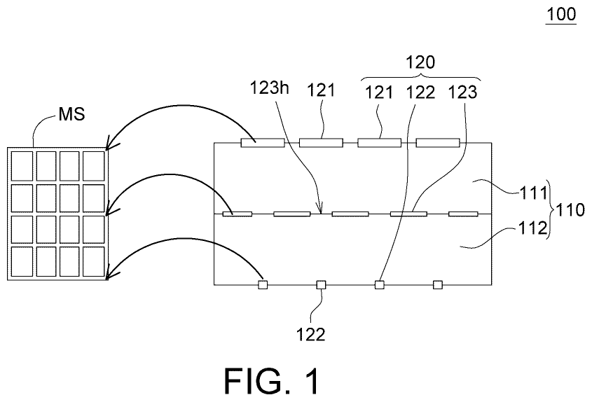

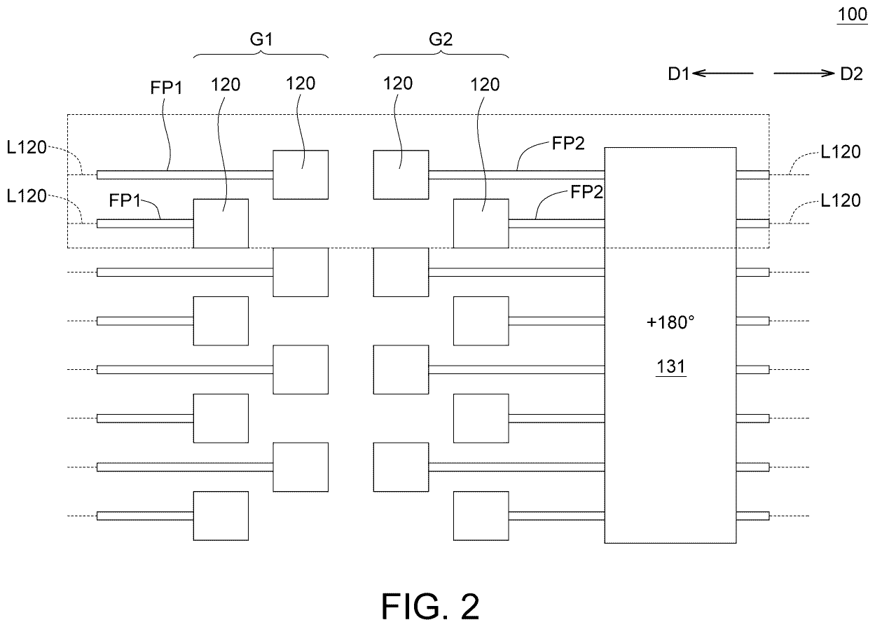

Please refer to FIGS. 1 and 2. FIG. 1 illustrates a cross-sectional view of a transparent antenna phase array 100 according to an embodiment of the present disclosure. FIG. 2 shows a top view of a transparent antenna phase array 100 according to an embodiment of the present disclosure. In this embodiment, the transparent antenna phase array 100 includes a transparent dielectric layer 110, a plurality of antenna units 120 and a first phase shift unit 131. The transparent dielectric layer 110 includes at least two transparent material layers 111, 112.

As shown in FIG. 1, the antenna unit 120 is disposed on the transparent dielectric layer 110. Each of the antenna units 120 includes an antenna conductive layer 121, a feed-in transmission line conductive layer 122 and a main ground opening conductive layer 123. The antenna conductive layer 121 is disposed on one of the transparent material layers 111, 112. The feed-in transmission line conductive layer 122 is disposed on one of the transparent material layers 111, 112. The main ground opening conductive layer 123 is disposed on one of the transparent material layers 111, 112. Transparent material layers 111 and 112 separate the antenna conductive layer 121 and the main ground opening conductive layer 123, and separate the feed-in transmission line conductive layer 122 and the main ground opening conductive layer 123.

As shown in the FIG. 1, the main ground opening conductive layer 123 is located between the antenna conductive layer 121 and the feed-in transmission line conductive layer 122. Each of the main ground opening conductive layers 123 has an opening 123h, and each of the openings 123h is located between the antenna conductive layer 121 and the feed-in transmission line conductive layer 122, so that the antenna conductive layer 121 and the feed-in transmission line conductive layer 122 could be electromagnetic coupled. The antenna conductive layer 121, the feed-in transmission line conductive layer 122 and the main ground opening conductive layer 123 are mesh structures MS, and their materials may include but are not limited to metal. The mesh structures MS are used to increase the light transmittance of the antenna.

As shown in the FIG. 2, the antenna units 120 are divided into a first group G1 and a second group G2. Each of the antenna units 120 is the mesh structure MS (shown in FIG. 1). Each of the antenna units 120 of the first group G1 has a first feed path FP1 extending toward a first direction D1. Each of the antenna units 120 of the second group G2 has a second feed path FP2 extending toward a second direction D2. The second direction D2 is different from the first direction D1. The first direction D1 is substantially 180 degrees different from the second direction D2 (If it is possible, the phase compensation is needed for different operating frequencies).

As shown in the FIG. 2, the first phase shift unit 131 is connected to the second feed paths FP2. The first phase shift unit 131 is used to provide a phase offset of 180 degrees (If it is possible, the phase compensation is needed for different operating frequencies). After the first phase shift unit 131 shifts the phase of the second feed path FP2 by 180 degrees, the shifted phase will be the same as the phase of the first feed path FP1.

As shown in the FIG. 2, the antenna units 120 are arranged in a plurality of extension lines L120 which are substantially parallel with each other, and the antenna units 120 arranged in two of the extension lines L120 which are adjacent are arranged in a cross arrangement/staggered arrangement.

Specifically, the antenna units 120 arranged in two of the extension line L120 which are adjacent are arranged in different projection positions. For example, the antenna units 120 of the first group G1 are staggered from the first column to the last column with right, left, and right, left, etc. The antenna units 120 of second group G2 are staggered from the first column to the last column in left, right, left, right, etc. The four antenna units 120 in the dotted box in the FIG. 2 form a 2×2 topology.

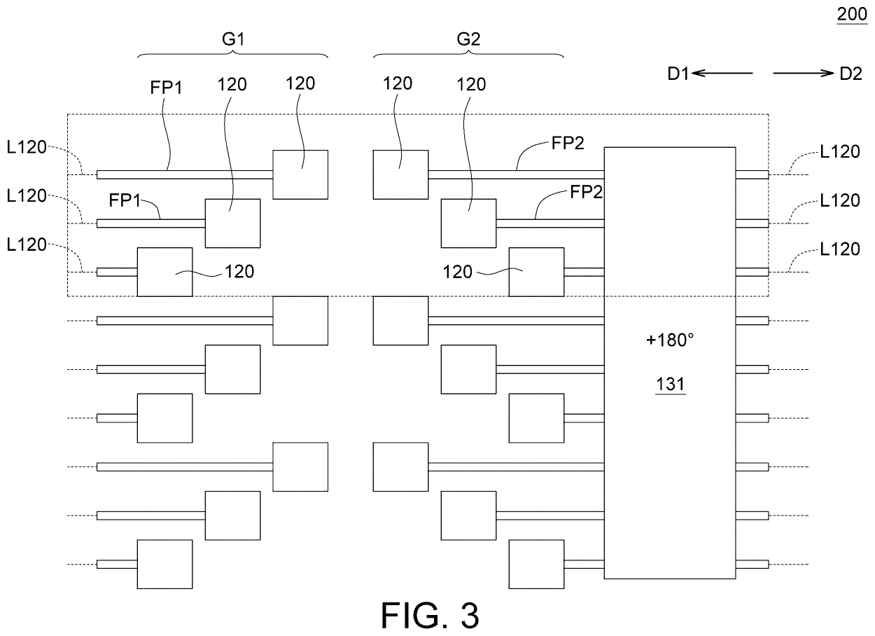

Please refer to FIG. 3, which illustrates a top view of a transparent antenna phase array 200 according to another embodiment of the present disclosure. In another embodiment, the antenna units 120 of the transparent antenna phase array 200 are arranged in a plurality of extension lines L120 which are substantially parallel with each other, and the antenna units 120 arranged in three of the extension lines L120 which are adjacent are arranged in different projection positions. For example, the antenna units 120 of the first group G1 are arranged from the first column to the last column in the order of right, center, left, right, center, left, etc.; and the antenna units 120 of the second group G2 are arranged from the first column to the last column in order left, center, right, left, center, right, etc. The first feed path FP1 of the antenna units 120 of the first group G1 extends towards the first direction D1, and the second feed path FP2 of the antenna units 120 of the second group G2 extends towards the second direction D2 to the first phase shift unit 131. The six antenna units 120 in the dotted box in the FIG. 3 form a 3×2 topology.

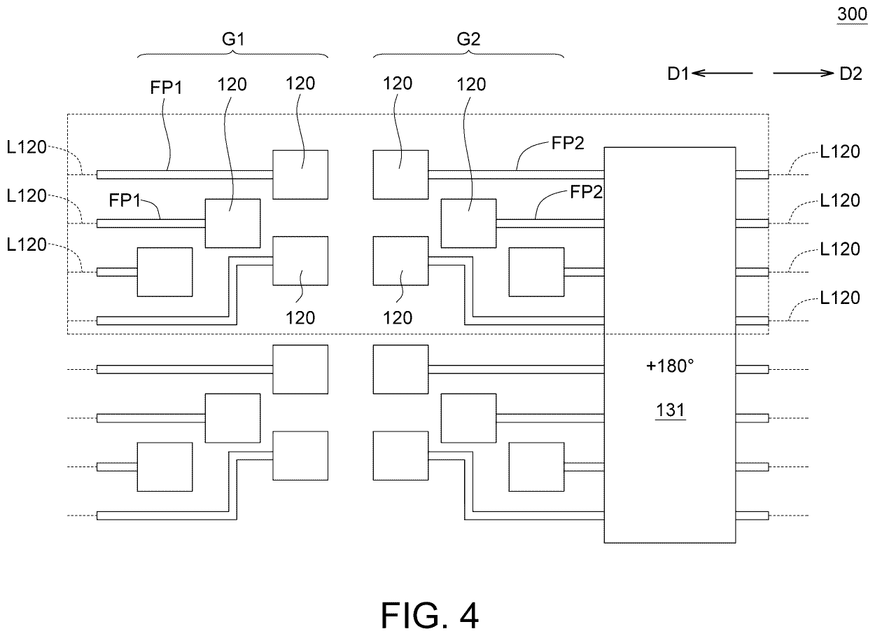

Please refer to FIG. 4, which illustrates a top view of a transparent antenna phase array 300 according to another embodiment of the present disclosure. In another embodiment, the antenna units 120 of the transparent antenna phase array 300 are arranged in a plurality of extension lines L120 which are substantially parallel with each other, and the antenna units 120 arranged in four of the extension lines L120 which are adjacent are arranged in different projection positions. For example, based on the 3×2 topology of the transparent antenna phase array 200, a new set of antenna units 120 is added in the middle of the transparent antenna phase array 300, so that the 8 antenna units 120 in the dotted line box in the FIG. 4 form a 4×2 topology.

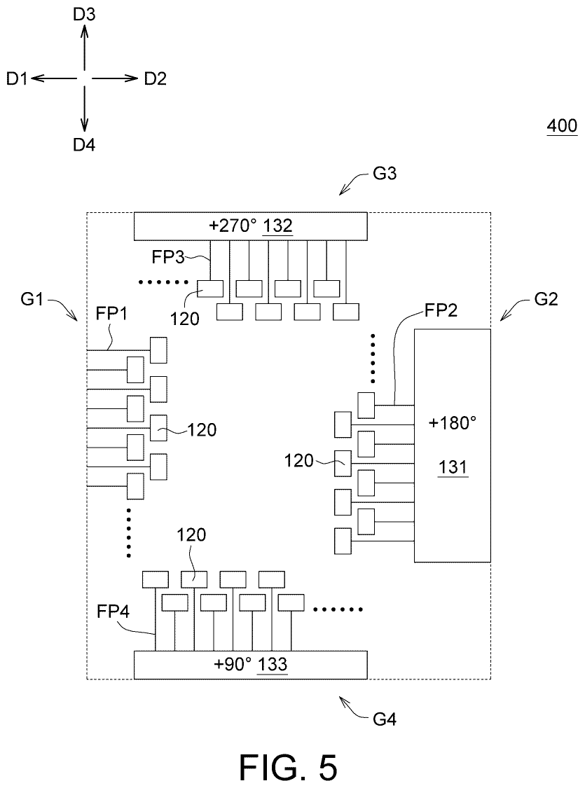

Please refer to FIG. 5, which illustrates a top view of a transparent antenna phase array 400 according to another embodiment of the present disclosure. In the embodiment of the FIG. 5, the transparent antenna phase array 400 further includes a second phase shift unit 132 and a third phase shift unit 133. The second phase shift unit 132 is connected to the third feed path FP3. The third phase shift unit 133 is connected to the fourth feed path FP4.

As shown in the FIG. 5, the antenna units 120 of the transparent antenna phase array 400 are divided into a first group G1, a second group G2, a third group G3 and a fourth group G4. The first group G1, the second group G2, the third group G3 and the fourth group G4 are arranged around a rectangle (not shown).

Each of the antenna units 120 of the first group G1 has a first feed path FP1 extending toward the first direction D1. Each of the antenna units 120 of the second group G2 has a second feed path FP2 extending toward the second direction D2. Each of the antenna unit 120 of the third group G3 has a third feed path FP3 extending in a third direction D3. Each of the antenna units 120 of the fourth group G4 has a fourth feed path FP4 extending in a fourth direction D4. The first direction D1, the second direction D2, the third direction D3 and the fourth direction D4 are different. The difference between the first direction D1 and the fourth direction D4 is 90 degrees, the difference between the fourth direction D4 and the second direction D2 is 90 degrees, the difference between the second direction D2 and the third direction D3 is 90 degrees, and the difference between the third direction D3 and the first direction D1 is 90 degrees.

As shown in the FIG. 5, the first phase shift unit 131 is used to provide a phase shift of 180 degrees (If it is possible, the phase compensation is needed for different operating frequencies), the second phase shift unit 132 is used to provide a phase shift of 270 degrees, and the third phase shift unit 133 is used to provide a phase shift of 90 degrees. Through the above phase shift, the antenna units 120 in different directions will be in the same phase after phase shift.

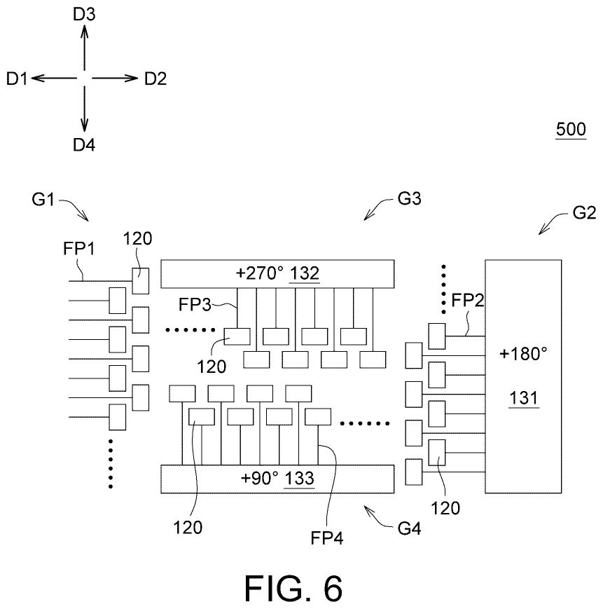

Please refer to FIG. 6, which illustrates a top view of a transparent antenna phase array 500 according to another embodiment of the present disclosure. In the embodiment of the FIG. 6, the third group G3 and the fourth group G4 of the transparent antenna phase array 500 are located between the first group G1 and the second group G2. That is to say, in this embodiment, the antenna units 120 of the third group G3 and the antenna units 120 of the fourth group G4 are concentrated in the middle of the transparent antenna phase array 500 without retaining the empty space, so that the arrangement could effectively save the space of the transparent antenna phase array 500.

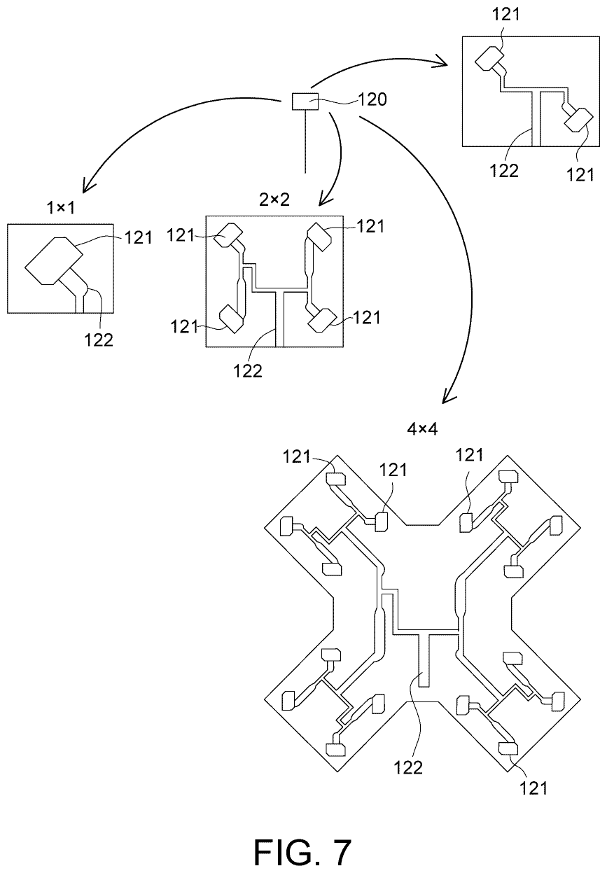

Please refer to FIG. 7, which illustrates a schematic diagram of the antenna unit 120 according to an embodiment of the present disclosure. The antenna unit 120 could be a linear polarization structure or a circular polarization structure. Taking the circular polarization structure as an example, the antenna unit 120 could adopt a 1×1 array circular polarization structure, a 1×2 array circular polarization structure, a 2×2 array circular polarization structure, or a 4×4 array circular polarization structure. In the 1×1 array circular polarization structure, one antenna conductive layer 121 is connected to one feed-in transmission line conductive layer 122. In the 1×2 array circular polarization structure, two antenna conductive layers 121 are connected to one feed-in transmission line conductive layer 122, and the antenna conductive layers 121 are arranged 180 degrees apart. In the 2×2 array circular polarization structure, four antenna conductive layers 121 are connected to one feed-in transmission line conductive layer 122, and each of the antenna conductive layers 121 is rotated 90 degrees in sequence. In the 4×4 array circular polarization structure, four 2×2 array circular polarization structures are rotated 90 degrees and arranged in sequence, and then the four 2×2 array circular polarization structures are connected in series with one feed-in transmission line conductive layer 122 to form the 4×4 array circular polarization structure.

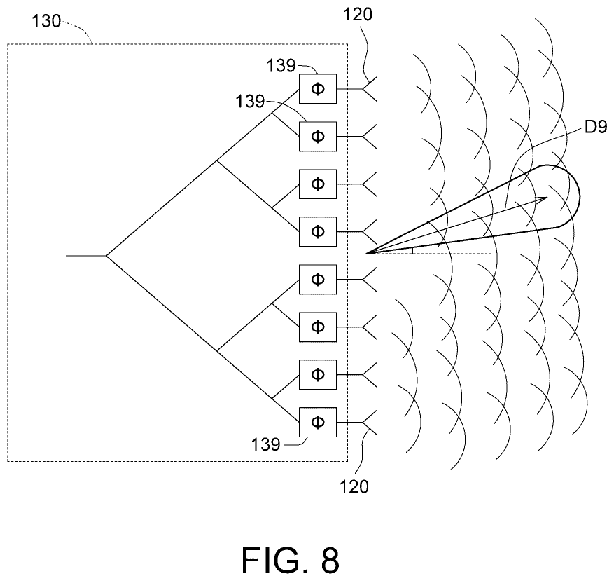

FIG. 8 illustrates a schematic diagram of a beamforming circuit 130 according to an embodiment of the present disclosure. The transparent antenna phase arrays 100, 200, 300, 400, 500 of different embodiments of the present disclosure may further include one or more beamforming circuits 130. After the antenna unit 120 feeds the signal into the beamforming circuits 130, the digital beamforming, the analog beamforming or the hybrid beamforming is used to change the direction D9 of the field pattern. Taking the FIG. 8 as an example, the phase shifter 139 provides a specific phase offset to each of the antenna units 120, so that the field pattern is directed to the direction D9.

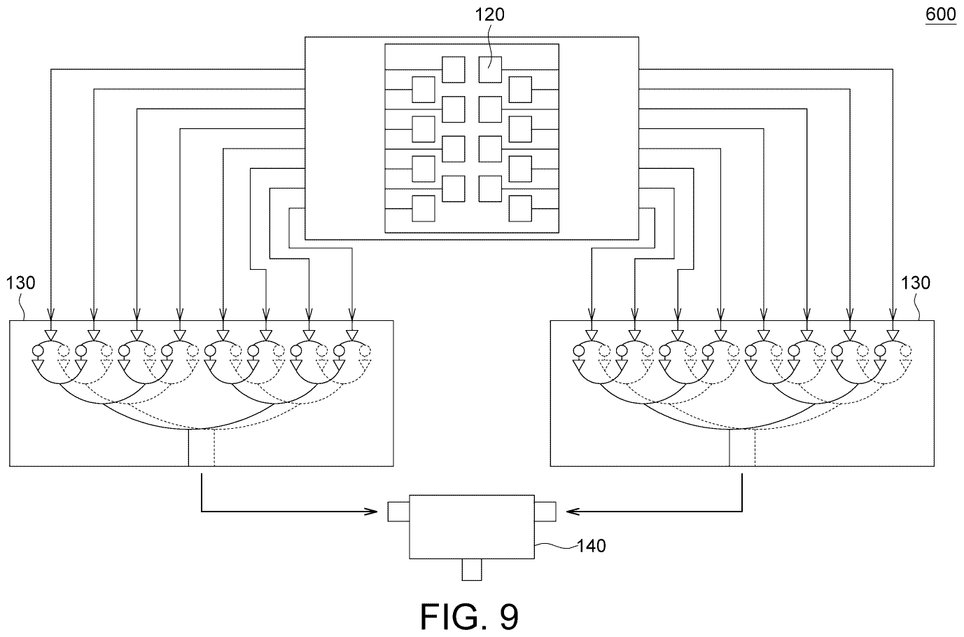

FIG. 9 shows a top view of a transparent antenna phase array 600 and a schematic diagram of the connection between the beamforming circuits 130 and the feeding integrated network 140 according to another embodiment of the present disclosure. In this embodiment, the transparent antenna phase array 600 includes more than one beamforming circuits 130 and one feeding integrated network 140. Each of the beamforming circuits 130 is connected to some of the antenna units 120. Taking the FIG. 9 as an example, each of the beamforming circuits 130 is connected to the connection ports of eight antenna units 120. The feeding integrated network 140 connects the beamforming circuits 130.

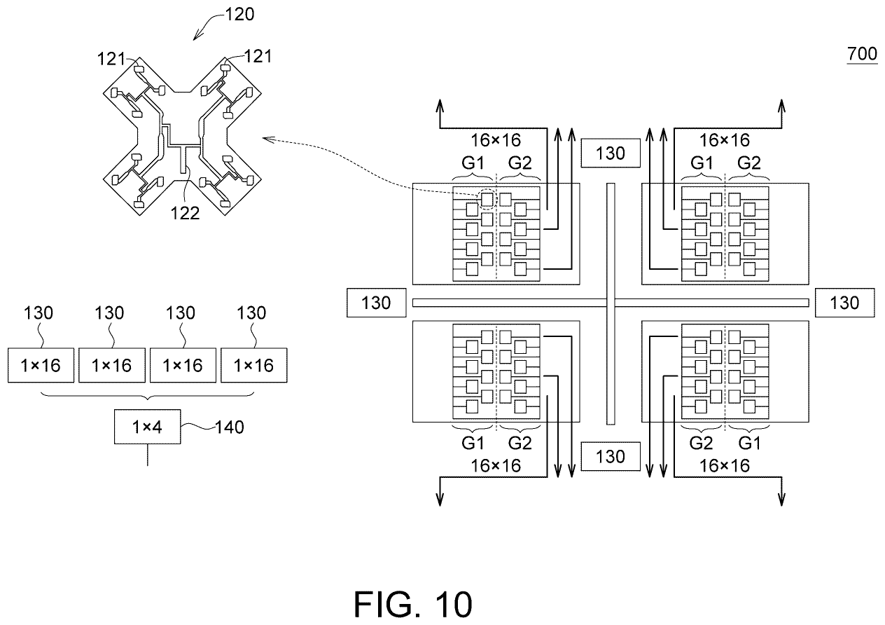

FIG. 10 shows a top view of a transparent antenna phase array 700 and a schematic diagram of the connection between the beamforming circuits 130 and the feeding integrated network 140 according to another embodiment of the present disclosure. In the embodiment of the FIG. 10, each of the antenna units 120 is, for example, a 4×4 array circular polarization structure. Four 16×16 arrays of the antenna units 120 form the transparent antenna phase array 700 with 1024 antennas. The four beamforming circuits 130 are individually connected to the 16 antenna units 120. The feeding integrated network 140 is connected to four beamforming circuits 130. These antenna units 120 form the transparent antenna phase array 700 with 1024 antennas.

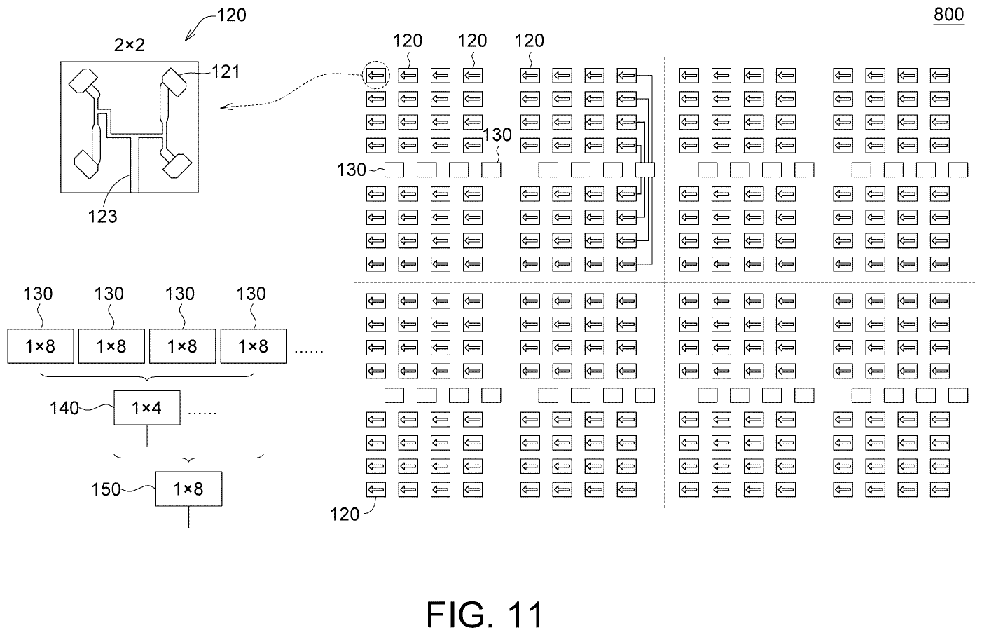

FIG. 11 illustrates a top view of a transparent antenna phase array 800 and a schematic diagram of the connection between the beamforming circuits 130 and the feeding integrated networks 140 and 150 according to another embodiment of the present disclosure. In the embodiment of the FIG. 11, each of the antenna units 120 is, for example, a 2×2 array circular polarization structure. Each of the beamforming circuits 130 is connected to 8 antenna units 120, one feeding integrated network 140 is connected to 4 beamforming circuits 130, and one integrated feeding network 150 is connected to 8 feeding integrated network 140. The antenna units 120 form the transparent antenna phase array 800 with 1024 antennas.

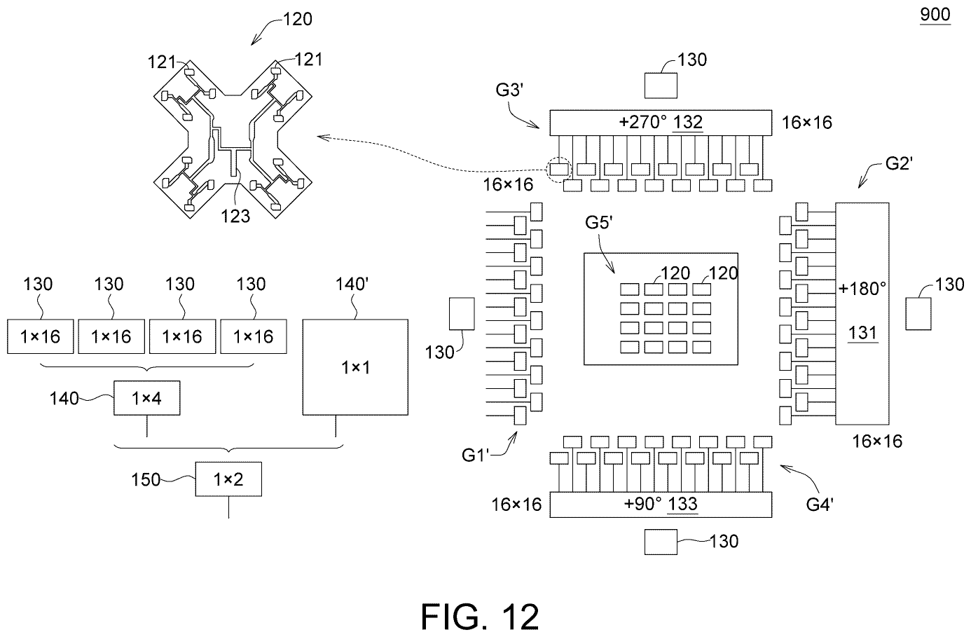

FIG. 12 illustrates a top view of a transparent antenna phase array 900 and a schematic diagram of the connection between the beamforming circuits 130 and the feeding integrated networks 140, 150 according to another embodiment of the present disclosure. In the embodiment of FIG. 12, each of the antenna units 120 is, for example, a 4×4 array circular polarization structure. The 16 antenna units 120 at the left side form the first group G1′, the 16 antenna units 120 at the right side form the second group G2′, the 16 antenna units 120 at the upper side form the third group G3′, and the 16 antenna units 120 at the lower side form the fourth group G4′. The 16 antenna units 120 in the middle form the fifth group G5′. The antenna units 120 of first group G1′, the second group G2′, the third group G3′ or the fourth group G4′ are arranged in a staggered arrangement. Each of the first group G1′, the second group G2′, the third group G3′ and the fourth group G4′ forms a 16×16 topology. The antenna units 120 of the fifth group G5′ are arranged in an array. The fifth group G5′ forms a 32×32 topology. The 16 antenna units 120 of the first group G1′ are connected to one beamforming circuit 130, the 16 antenna units 120 of the second group G2′ are connected to one beamforming circuit 130, the 16 antenna units 120 of the third group G3′ are connected to one beamforming circuit 130, and the 16 antenna units 120 of the fourth group G4′ are connected to one beamforming circuit 130. The four beamforming circuits 130 are connected to one feeding integrated network 140, and the fifth group G5′ is connected to another feeding integrated network 140′. Then, the feeding integrated networks 140, 140′ are connected to the feeding integrated network 150. The antenna units 120 form the transparent antenna phase array 900 with 2048 antennas.

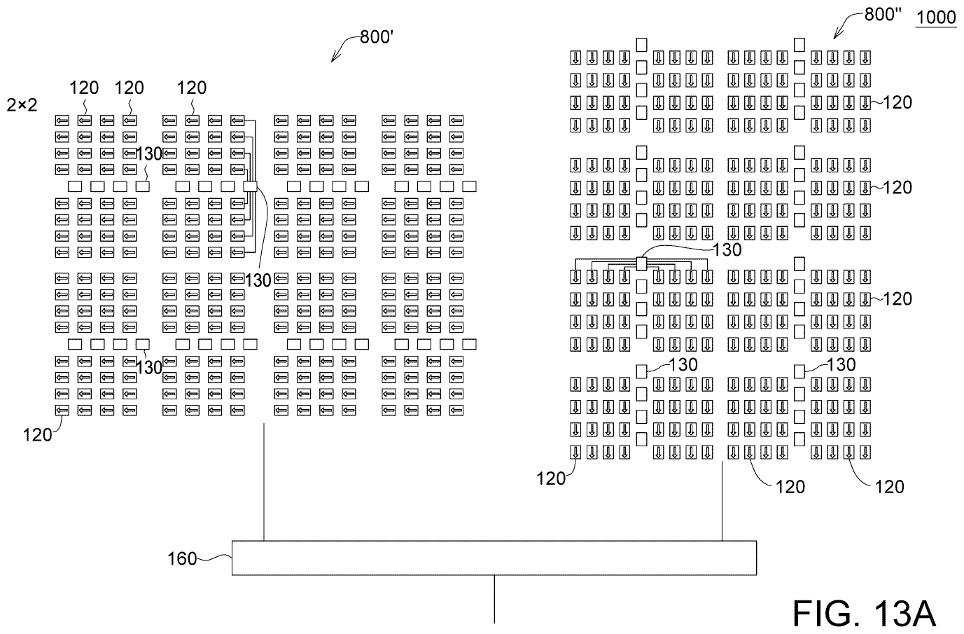

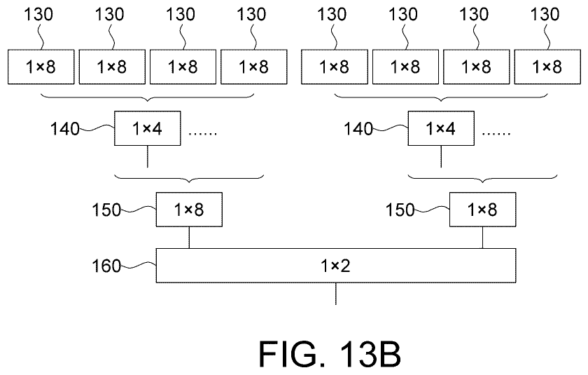

Please refer to FIGS. 13A to 13B. FIG. 13A illustrates a top view of a transparent antenna phase array 1000 according to another embodiment of the present disclosure. FIG. 13B illustrates a schematic diagram of the connection between the beamforming circuits 130 and the feeding integrated networks 140, 150, 160 of the transparent antenna phase array 1000 of the FIG. 13A. The feeding integrated network 160 is, for example, a combiner or a switch. In the embodiment of FIGS. 13A to 13B, two transparent antenna phase arrays 800′, 800″ are connected to the integrated feeding network 160. The transparent antenna phase array 800′ is, for example, the transparent antenna phase array 800 in FIG. 11, and the transparent antenna phase array 800″ is, for example, the transparent antenna phase array 800 in FIG. 11, rotated by 0 degrees or 90 degrees. The antenna units 120 form a transparent antenna phase array 1000 with 2048 antennas.

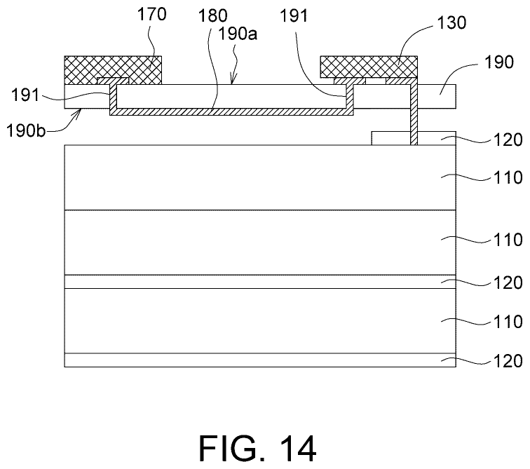

Please refer to FIG. 14, which illustrates a schematic diagram of the connection between the beamforming circuit 130 and the antenna unit 120 according to an embodiment of the present disclosure. The beamforming circuit 130 and other circuits (such as the power management circuit 170) are arranged on a dielectric layer 190. The dielectric layer 190 is, for example, a circuit board or an insulating material layer. The dielectric layer 190 is disposed on the transparent dielectric layer 110 and the antenna unit 120. The wiring layer (RDL) 180 is disposed on the first surface 190a and the second surface 190b of the dielectric layer 190. The wiring layer 180 disposed on the first surface 190a and the wiring layer 180 disposed on the second surface 190b are connected through a conductive via 191 of the dielectric layer 190. Through the configuration of the wiring layer 180, the beamforming circuit 130 and the power management circuit 170 are connected to the antenna unit 120.

According to the various transparent antenna phase arrays proposed in the above embodiments, the array design, the electromagnetic coupling technology, the beam forming, and the circular polarization radiation are used to allow the transparent antenna to have ultra-high gain, directivity, and circular polarization radiation capabilities.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A transparent antenna phase array, comprising:
a transparent dielectric layer, including at least two transparent material layers; and
a plurality of antenna units, wherein each of the antenna units includes:
an antenna conductive layer, disposed on one of the transparent material layers;
a feed-in transmission line conductive layer, disposed on one of the transparent material layers; and
a main ground opening conductive layer, disposed on one of the transparent material layers, and disposed between the antenna conductive layer and the feed-in transmission line conductive layer, wherein the antenna conductive layer, the feed-in transmission line conductive layer and the main ground opening conductive layer are mesh structures, and the transparent material layers separate the antenna conductive layer and the main ground opening conductive layer, and separate the feed-in transmission line conductive layer and the main ground opening conductive layer.

2. The transparent antenna phase array according to claim 1, wherein each of the main ground opening conductive layers has an opening, each of the openings is disposed between the antenna conductive layer and the feed-in transmission line conductive layer.

3. The transparent antenna phase array according to claim 1, wherein the antenna units are arranged in a plurality of extension lines which are substantially parallel with each other, and the antenna units arranged in two of the extension lines which are adjacent are arranged in a staggered arrangement.

4. The transparent antenna phase array according to claim 1, wherein the antenna units are arranged in a plurality of extension lines which are substantially parallel with each other, and the antenna units arranged in two of the extension lines which are adjacent are arranged in different projection positions.

5. The transparent antenna phase array according to claim 1, wherein the antenna units are arranged in a plurality of extension lines which are substantially parallel with each other, and the antenna units arranged in three of the extension lines which are adjacent are arranged in different projection positions.

6. The transparent antenna phase array according to claim 1, wherein each of the antenna units has a linear polarization structure or a circular polarization structure.

7. A transparent antenna phase array, comprising:
a transparent dielectric layer;
a plurality of antenna units, disposed on the transparent dielectric layer, wherein the antenna units are at least divided into a first group and a second group, each of the antenna units is a mesh structure, each of the antenna units of the first group has a first feed path extending in a first direction, and each of the antenna units of the second group has a second feed path extending in a second direction, the second direction is different from the first direction; and
a first phase shift unit, connected to the second feed path.

8. The transparent antenna phase array according to claim 7, wherein the first direction is substantially 180 degrees different from the second direction.

9. The transparent antenna phase array according to claim 7, wherein the first phase shift unit is used to provide a phase shift of 180 degrees.

10. The transparent antenna phase array according to claim 7, wherein the antenna units are arranged in a plurality of extension lines which are substantially parallel with each other, and the antenna units arranged in two of the extension lines which are adjacent are arranged in a staggered arrangement.

11. The transparent antenna phase array according to claim 7, wherein the antenna units are arranged in a plurality of extension lines which are substantially parallel with each other, and the antenna units arranged in two of the extension lines which are adjacent are arranged in different projection positions.

12. The transparent antenna phase array according to claim 7, wherein the antenna units are arranged in a plurality of extension lines which are substantially parallel with each other, and the antenna units arranged in three of the extension lines which are adjacent are arranged in different projection positions.

13. The transparent antenna phase array according to claim 7, wherein the antenna units are divided into the first group, the second group, a third group and a fourth group, each of the antenna units of the third group has a third feed path extending in a third direction, each of the antenna units of the fourth group has a fourth feed path extending in a fourth direction, and the first direction, the second direction, the third direction and the fourth direction are different.

14. The transparent antenna phase array according to claim 13, wherein the first direction is 90 degrees different from the fourth direction, the fourth direction is 90 degrees different from the third direction, and the third direction is 90 degrees different from the first direction.

15. The transparent antenna phase array according to claim 13, further comprising:
a second phase shift unit, connected to the third feed path; and
a third phase shift unit, connected to the fourth feed path.

16. The transparent antenna phase array according to claim 15, wherein the second phase shift unit is used to provide a phase shift of 270 degrees, and the third phase shift unit is used to provide a phase shift of 90 degrees.

17. The transparent antenna phase array according to claim 13, wherein the first group, the second group, the third group and the fourth group are arranged around a rectangle.

18. The transparent antenna phase array according to claim 13, wherein the third group and the fourth group are located between the first group and the second group.

19. The transparent antenna phase array according to claim 7, further comprising:
a plurality of beamforming circuits, disposed on the transparent dielectric layer, wherein each of the beamforming circuits is connected to some of the antenna units; and
a feeding integrated network, connected to the beamforming circuits.

20. A transparent antenna phase array, comprising:
a transparent dielectric layer;
a plurality of antenna units, arrayed on the transparent dielectric layer, wherein each of the antenna units is a mesh structure;
a plurality of beamforming circuits, disposed on the transparent dielectric layer, wherein each of the beamforming circuits is connected to some of the antenna units; and
at least one feeding integrated network, connected to the beamforming circuits.
